(19) United States
(12) Patent Application Publication
(10) Pub. No.: US 2008/0256558 A1
(43) Pub. Date: Oct. 16, 2008

(54) AMBIENT SOFTWARE INTEGRATION SYSTEM

(76) Inventor: Zachary Buckner, Charlottesville, VA (US)

Correspondence Address: W. EDWARD RAMAGE, COMMERCE CENTER SUITE 1000, 211 COMMERCE ST, NASHVILLE, TN, 37201, US

(21) Appl. No.: 12/100,710

(22) Filed: Apr. 10, 2008

Related U.S. Application Data
(60) Provisional application No. 60/910,847, filed on Apr. 10, 2007.

(51) Int. Cl. G06F 3/00

(52) U.S. Cl. 719/323; 382/190

(57) ABSTRACT

A software extension that monitors a hardware-level or operating system-level representation of the visual state of a running computer application. The software extension processes the time-sequence of visual information extracted to approximate some of the internal, non-graphical application data structures and program state. The software transforms, refines, or augments the data acquired with acquired personal data or network data to form derived data. The derived data then is presented to the user to create a new application feature. This presentation may be displayed alongside the application or operating system's existing graphical user interface.

This application claims benefit of, and priority to, U.S. Provisional Patent Application No. 60/910,847, filed Apr. 10, 2007, entitled “AMBIENT SOFTWARE INTEGRATION SYSTEM.” The complete specification, drawings, attachments and disclosure of U.S. Provisional Patent Application No. 60/910,847 are incorporated herein by specific reference.

### FIELD OF INVENTION

This invention relates to a system for extending software applications. More particularly, the invention relates to a system for integrating with different software applications, leveraging the application data and functionality, and providing new features that are unobtrusively integrated with the applications' existing interfaces.

### BACKGROUND

The traditional way to build software extensions is to use the base program's Application Programming Interface (API). Third-party software developers have used APIs to build countless software extensions to popular applications like Microsoft Word and Firefox. However, the technique is problematic for several reasons. APIs are specific to particular applications, making it time-consuming for developers to write programs that interact with more than one base application. Software extensions must be built using technologies that are compatible with the base application, reducing flexibility for developers (for example, a Windows application like Microsoft Word could not be extended conveniently by a Java application). In addition, software extensions may interfere with the base application. For example, the Adobe Acrobat Writer's toolbar is notorious for interfering with the Microsoft Office applications that it attempts to extend.

Accordingly, what is needed is a system and method for building software extensions that need not be compatible with the base application, and that does not interfere with the base application.

### SUMMARY OF THE INVENTION

The present invention uses the graphical image displayed by a base application, as opposed to using an exposed programming interface. By analyzing a sequence of such images, a software extension in accordance with one exemplary embodiment of the present invention can approximate the state of the base application and display additional graphical features beside or overtop the existing application's graphical user interface.

A software extension according to an embodiment of the present invention can conveniently extend the functionality of many different base applications, as separate applications with similar visual facades can, in some cases, be treated in similar ways. Software extensions also can be written using technologies and languages far different than those of the base application. Software extensions also can be far less likely to interfere with the base applications, as the extensions can be run in isolated processes and can rely only on the visual facades accessed through hardware or through the operating system.

### DESCRIPTION OF THE DRAWINGS

FIG. 1 shows a schematic diagram of a system in accordance with one embodiment of the present invention.

FIG. 2 shows a user interface for an example of a design application in accordance with an embodiment of the present invention.

FIG. 3 shows a view of derived information superimposed on the user interface of FIG. 2.

### DETAILED DESCRIPTION OF EXEMPLARY EMBODIMENTS

In one exemplary embodiment, the present invention comprises a software extension monitoring a hardware-level or operating system-level representation of the visual state of a running computer application. Examples of such representations include, but are not limited to, a video buffer stored on the computer system's hardware video adapter, an operating-system level video buffer, a collection of operating-system level paint instructions, or an operating system-level message loop.

In each case, the component that contains such visual representations is available for analysis by directly accessing the internal system state of a visual representation that is originally presented to or potentially present to the end user. One persistent mode or example of this visual representation would be a “screen shot” of the user's current desktop. The visual representation that may be contained in the above component, however, can be more extensive than what would be seen by the user. It may contain pre-rendered components of a programs visual interface that are currently located off screen or hidden behind foreground windows. All of these different visual representations are subject to analysis by an embodiment of the present invention whether or not they are directly presented to an end user via a display device, such as a monitor or LCD screen.

The operating-system level information can provide additional non-visual information for placing visual elements in the above component into specific context for analysis. An example of this is the mechanism where an operating system such as Microsoft Windows provides information about which currently running application controls which window in the foreground of the user's display. The invention can monitor and capture information such as this in addition to the actual visual representation in the previous components to construct a set of features for analysis that are composed of both direct, well-structured information about the running application(s) and the visual representations being constructed by the application(s) and the operating-system. This embodiment is targeted toward individual computer systems where the application(s) are running on a local computer—i.e., what are called “fat client” applications. In “thin client” applications, where data processing is performed on a remote server and the client's user interface is periodically updated or refreshed via network transmissions, these network transmissions would also constitute a representation of the visual state of an application. All other aspects related to “fat client” embodiment would be applicable to the “thin client” embodiment in so far as the “thin client” embodiment could gain access to information about the local computer's state.

The software extension processes the time-sequence of visual information extracted, as described above, to approximate some of the internal, non-graphical application data structures and program state. This may include the recognition of textual strings that are present in the visual representation, as well as shapes, or expected patterns (such as a “box” on the screen that matches up to expected appearance of a window of a known application or an icon that maps to a known application). For example, the changing visual state of a Microsoft Outlook email client might reveal an approximation of the user's inbox contents. Particularly visual features of the Microsoft Outlook application could be recognized in the analysis of the visual state and be used to determine both the application's identity and infer information about the state of the application. For instance, knowing that a “new message” window that has incomplete sentences in it—as determined by recognizing text in the screen, analyzing the text through a Natural Language Parser—that is in the foreground of the screen may provide the invention with sufficient information to realize that a user is trying to send a message to the person(s) in the “To:” line of the email. This may trigger a specific context in the Ambient Software Integration System to assist the user in some way—such as by summarizing recent emails to that person in a pop up window. Some of Microsoft Outlook's internal variables (such as the IP address of the mail server) may not be revealed, however. And although the pixel layout of Microsoft Outlook's GUI is related to the application's state, this is not itself considered a part of the internal, non-graphical state.

The software transforms, refines, or augments the data acquired above with passively acquired personal data or network data to form derived data. Information derived by inspecting the user's behavior, network activity, or local file contents may be considered passively acquired personal data. Example of such personal data include, but are not limited to, visited web pages, chat activity through an instant messaging client, downloaded files, and recently modified spreadsheets and documents. Also, data that is automatically and frequently retrieved or updated from a computer network without the user's direct involvement may be considered passively acquired network data. Examples of such network data include, but are not limited to, telephone and email directories, dictionaries and thesauri, map and gazetteer data, catalogs, account balances, securities pricing data, and regional event data. However, data that is recorded or updated by some explicit action from the user (like the addition of a specialized term to a spell checking dictionary) is not considered to be “passively acquired.” Similarly, data that is retrieved from the network during the installation of a program or that is retrieved by some manual action from the user is not considered to be “passively acquired.”

The derived data is then used to create a new application feature, which is presented to the user alongside or overlaying the application or operating system's existing graphical user interface. For example, the data could be unobtrusively presented in a translucent graphical area overlaid upon an email application. The software extension does not simply provide an alternate interface for an application, or allow the user to access existing features of the application using a different mode of input or output. Instead, the extension provides additional functionality that leverages the derived data.

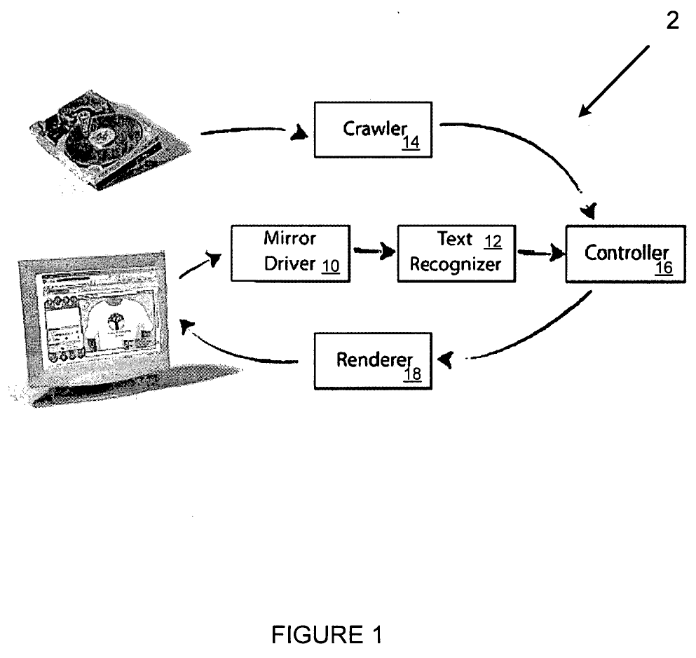

FIG. 1 shows an exemplary embodiment of the present invention. The software extension 2 comprises a multi-component program running within an operating system, such as, but not limited to, a version of Microsoft's Windows operating system. The components in this embodiment comprise a mirror display driver 10 adapted to “observe” the visual state of the user's desktop, a text recognizer 12 adapted to translate on-screen data into strings, a crawler 14 adapted to harvest personalized data from the user's local files and browser history, a controller 16 adapted to match strings from the user interface with relevant, personalized data from the user's local files, and a renderer 18 adapted to display these matched links atop the graphical user interface. These components can monitor the user's working environment and suggest documents and visited web sites that are related to the currently observed task.

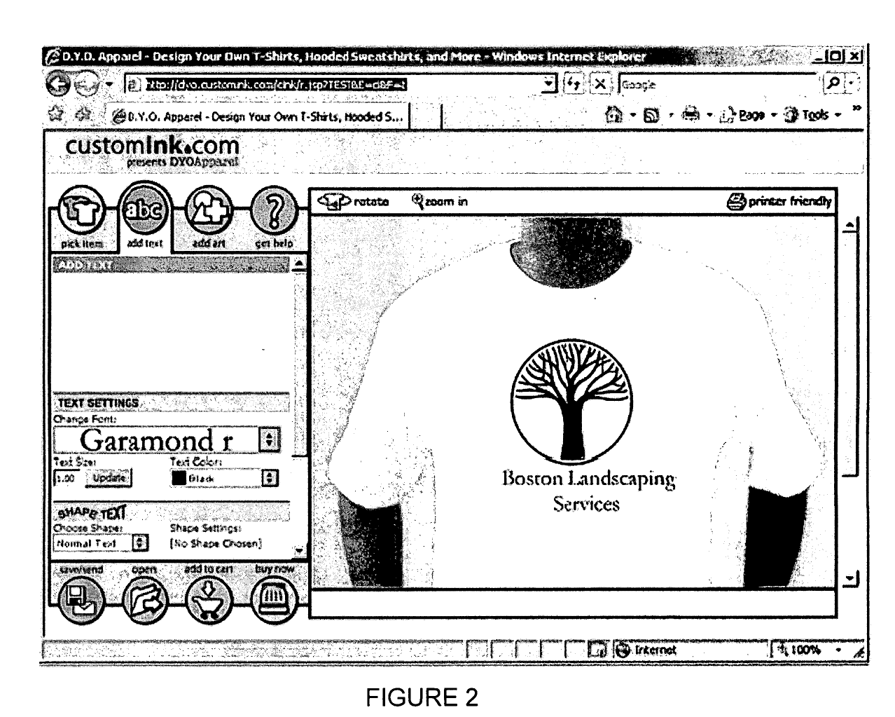

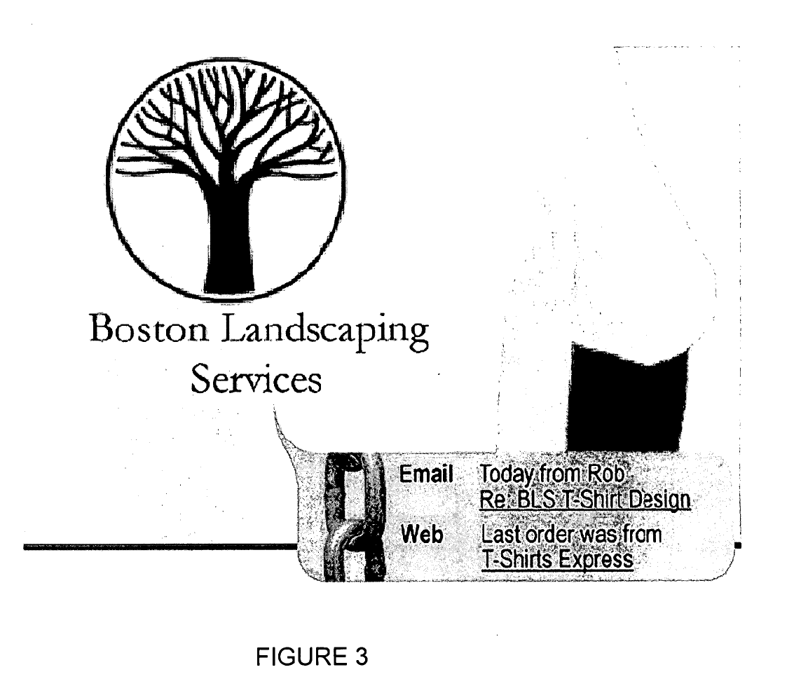

FIG. 2 shows another exemplary embodiment of the present invention, where the user is designing a T-shirt for a company. The mirror driver 10 reports exactly what the user sees, and the text recognizer 12 extracts strings like “Design Your Own T-Shirts” and “Boston Landscaping Services”. This textual data is reported to the controller 16, which matches these strings to data from the user's local files and browser history. In this example, the controller 16 matched an important recent email and a saved receipt from a previous purchase. These relevant links are presented by the renderer 18, as shown in FIG. 3.

Accordingly, in one exemplary embodiment, the present invention is a system for processing information, comprising a computer for running software programs either as stand alone device or in a distributed network, said computer in a distributed network including a processing means in communication with said distributed network; at least one storage means in communication with said processing means for storing programs and information; and at least one mechanism in said computer for temporarily retaining and presenting visual representation of running programs to an end user; wherein said computer with a mechanism for retaining visual presentations running programs and said at least one storage means are operable for monitoring the visual representation of the computer's state as actually or potentially presented to a user, and/or monitoring other operating-system information that provides context to the components contained in the said visual representation. Either or both of these elements are analyzed by the system to infer information about the state of applications running on said computer. Additional information related to the application state is acquired passively and extracted from data sources either present on the computer or available through a network. This acquired information and the inferred information about the application state is used to trigger another application assisting the user or providing additional functionality to one or more of the application(s) currently running.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

1. A software extension system, comprising:
a mirror display driver adapted to observe the visual display of a computer.

2. The system of claim 1, further comprising a text recognition module adapted to translate data in the visual display into strings.

3. The system of claim 2, further comprising a harvester module adapted to collect data from files, browser history, and other data sources on the computer.

4. The system of claim 3, further comprising a controller, said controller adapted to match strings from the text recognition module with data collected by the harvester module.

5. The system of claim 4, further comprising a rendering module using the matched strings and data to create a modified visual display on the computer.

6. A system for processing information, comprising:
at least one mechanism in a computer for temporarily retaining and presenting a visual representation of programs running on the computer.

7. The system of claim 6, further comprising at least one mechanism in the computer for monitoring operating-system information that provides context to components in the visual representation.

8. The system of claim 7, wherein the visual representation, operating system information, or both, are analyzed to infer information about the state of applications running on the computer, further wherein other information about the application state is acquired passively, and further where this acquired information and the inferred information are used to trigger another application.

9. The system of claim 8, wherein the inference about the state of the applications running on said system is augmented by stored or trained patterns that the system is taught to recognize.

10. The system of claim 9, wherein the stored or trained patterns include words, characters, icons, shapes, visual application structures, or visual artifacts that provide information about the state of the application and the system.

11. The system of claim 8, wherein the triggered application presents itself as a visual overlay on the visual display of the computer.

12. The system of claim 11, wherein the visual overlay appears to be a direct extension of a running application by directly visually extending or augmenting a foreground window of the running application.

13. The system of claim 11, wherein the visual overlay appears as a special context menu, such as one triggered by a right click action on a personal computer.

14. The system of claim 8, wherein the inferred information or acquired information, or both, is distributed to another computer over a network to trigger an application that is running on said other computer.

15. The system of claim 8, wherein the information is used for the function of searching a local system's persistent storage.

16. The system of claim 8, wherein the information is used for the function of querying an Internet or network search engine.

17. The system of claim 8, wherein the information is transmitted between different applications running on the same computer.
